(19) United States
(12) Patent Application Publication
(10) Pub. No.: US 2022/0109263 A1
(43) Pub. Date: Apr. 7, 2022

(54) PLUG CONNECTOR WITH HIGH-VOLTAGE FLASHOVER PROTECTION

(71) Applicant: HIRSCHMANN AUTOMOTIVE GMBH, Rankweil/Brederis (AT)

(72) Inventors: Markus KALB, Dornbirn (AT); Alfonso FERNANDEZ CARDENOSA, Feldkirch (AT)

(21) Appl. No.: 17/425,118

(22) PCT Filed: Feb. 15, 2019
(86) PCT No.: PCT/EP2019/053843

§ 371 Date: Jul. 22, 2021

(51) Int. Cl. H01R 13/436; H01R 13/506

(52) U.S. Cl. CPC H01R 13/4361; H01R 13/506

(57) ABSTRACT

The invention relates to a plug-in connector (1) having a contact support (2) with at least two contact cavities (3), in each of which a contact partner is inserted and primarily locked. At least one locking tab (4) is provided and has at least one locking pin (6), and each respective contact partner is secondarily locked in its contact cavity (3) by means of a respective locking pin (6). The invention is characterized in that a slot (8) is arranged in the contact support (2) between two contact cavities (3), and the locking tab (4) has a rib (7), said rib (7) engaging into the slot (8) when the locking tab (4) is located on the contact support (2) in its intended position.

The invention relates to a plug-in connector comprising a support with at least two contact chambers into each of which a respective contact is inserted and primary-locked there, and there is at least one locking tab that has at least one locking pin, and a respective contact is secondary-locked in its contact chamber by a respective locking pin, in accordance with the features of the preamble of patent claim 1.

A plug-in connector of the type in question is known from DE 101 57 564. This known plug-in connector has a support with at least two contact chambers (in this case, two rows each having four contact chambers). A contact is inserted in each contact chamber and primary-locked during this process. This is undertaken, for example, in a manner known per se by a resilient tab that protrudes from the contact and comes to bear against an undercut in the contact chamber. As the contact is inserted into the contact chamber, the resilient tab is pushed back slightly here and can jump forward again when the contact has reached its correct position in the contact chamber. What is referred to as the primary locking is thus realized.

In addition, for the secure and the permanent fixing of each contact in its contact chamber, it is known from this generic prior art that what is referred to as secondary locking of the contacts takes place. This is realized by there being a locking tab that, in this case, is on the support. The locking tab (in this case two locking tabs that are arranged lying opposite each other) has a latching hook at its free protruding end, and this latching hook is first of all arranged at a spacing from the support for as long as the locking tab is not yet in its correct end position. This end position is reached only when each contact has been inserted into its associated contact chamber and primary-locked there. The locking tab is subsequently moved into its correct end position such that its latching hook, for example by entering in the contact chamber, can secondary-lock the contact located there. The correct end position of the locking tab on the support is simultaneously also taken up permanently using the latching hook.

The constructional form of this known plug-in connector is relatively small, and therefore a cross section of the respective contact chambers of a few square millimeters (for example a cross section of two times two millimeters) is produced. In addition, the individual contact chambers are separated from one another only by relatively narrow webs, for example having a width of one to three millimeters. There is thereby the risk that, during the energy or signal transmission, undesirable flashovers (in particular high-voltage flashovers) occur between the individual contacts depending on the transmitted energies or types of signals. This is because the individual contact chambers are arranged very close together and therefore the spacing for creepage currents is short. This can lead to disadvantageous distortions during the signal transmission and even to short circuits during the energy transmission via the individual contacts of the plug-in connector.

The invention is therefore based on the object of improving such a known plug-in connector to the effect that the disadvantages outlined at the beginning are significantly avoided.

This object is achieved by the features of patent claim 1.

According to the invention, it is provided that a slot is between two contact chambers in the support and the locking tab has a web, and the web enters the slot when the locking tab is fitted to the support. The slot runs substantially parallel to the longitudinal axis of the contact chamber. It extends over the entire length of the contact chamber, but may also be shorter or extend over a greater length in the support. The slot in the support increases the spacing for the creepage currents that occur, and therefore flashovers between contacts of adjacent contact chambers are thereby significantly reduced and ideally completely avoided. This effect is increased by the fact that a web enters this slot. This entry is simplified during the installation of the plug-in connector by the respective web that is assigned to each slot being located on the locking tab. By means of the at least one locking pin (referred as a latching hook in the prior art, with it also being possible for other terms to be used for the means for the functionality of the secondary locking) and at least one web on the locking tab, when the locking tab is brought into its correct end position on the support, both the secondary locking and the entry of the web into its associated slot are realized simultaneously, as a result of which only one single installation step is required for the secondary locking and for the reduction of flashovers.

For this single installation step, in a development of the invention, as is also already known in the prior art, the at least one locking tab is pivotal on the support. This has the advantage that the support can be produced together with its contact chambers and the locking tab as an integral component. Since the support has to have insulating properties and is therefore produced from plastic, a plastics injection molding process is appropriate. For this purpose, after this integral component is produced, the locking tab is on the support via a thin connection, for example in the form of a film hinge, and, after the production, its free end initially protrudes for a spacing from the support. Only when the contacts have all been inserted into their associated contact chambers and primary-locked there is the locking tab pivoted from its protruding position into its correct end position, with the secondary locking and the entry of the at least one web into its associated at least one slot taking place simultaneously.

Alternatively thereto, it is provided according to the invention that a frame is provided that is fixed on the support, and the at least one locking tab is pivotal on the frame. At least one locking tab, optionally also a plurality of locking tabs, are integrally arranged pivotably on the frame. An arrangement of the at least one locking tab on the support via a film hinge is also suitable here. The frame is furthermore configured geometrically in such a manner that it can be fixed on the support, for example on the end side in the direction of the plug face of the plug-in connector, in a suitable manner. This fixing takes place, for example, by adhesive bonding, pressing on, latching or the like.

Alternatively, the locking tab can also be produced and mounted as an independent component detached from the support and/or the frame and can carry out the function here both of the secondary locking and of the entry of the webs into the slots.

In a development of the invention, it is provided that a minimum clearance remains between the surface of the web and the surface of the associated slot when the web has entered its slot. The creepage distance is thereby extended once again and, by means of the minimum clearance in the form of an (albeit very small) air volume, an additional insulation is produced with which the flashovers between the adjacent contacts are once again significantly reduced or even prevented. This effect is preferably also increased by the fact that the web (and optionally the entire locking tab on which the at least one web is or from which the latter is formed) and the support are formed from differing material from each other. This produces a dielectric, as a result of which the flashovers are significantly reduced once again. A locking tab with its webs (or optionally only the webs) of different materials with regard to the support can be produced, for example, by a known two component injection molding process.

An embodiment of a plug-in connector according to the invention, to which, however, the invention is not restricted, will be described below and is explained with reference to the drawing.

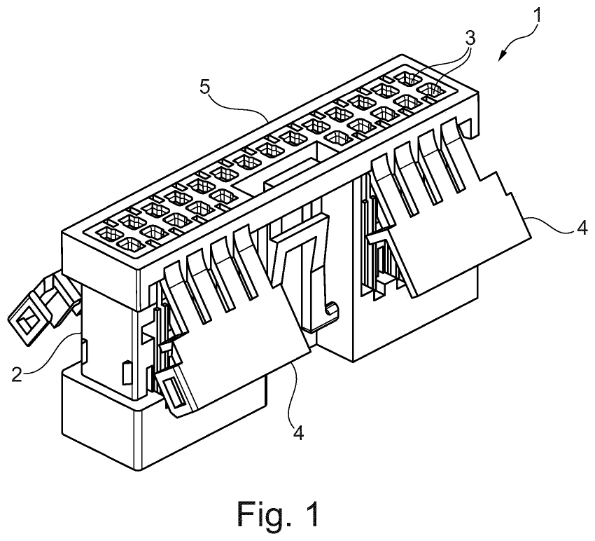

FIG. 1, to the extent illustrated specifically, shows a plug-in connector 1 that has a support 2. By way of example, two rows each having five contact chambers 3 and one row having four contact chambers 3 are arranged in the support 2. The number of contact chambers and of the rows is not restrictive and may be one row, two rows or even a plurality rows, with the number of contact chambers 3 also being able to be selected in accordance with the field of use of the plug-in connector 1.

The plug-in connector 1 according to FIG. 1 furthermore has at least one locking tab 4, here a total of four locking tabs 4. These locking tabs 4 can be arranged directly on the support 2 (not illustrated in FIG. 1). The embodiment is illustrated in which the plug-in connector 1 comprises a frame 5, and the four locking tabs 4 extend from this frame 5 and protrude with their end region somewhat from the support 2. The frame 5 for its part is at the upper end of the support 2, which end forms the plug face of the plug-in connector 1, from which a mating plug-in connector, not illustrated, can be plugged into the plug-in connector 1. A reverse arrangement of the locking tab 4 directly on the support 2 or a reverse arrangement of the frame 5 on the support 2 is also conceivable by, for example, the frame 5 being fixed on that end of the support 2 that faces away from the plug face. It is important for the invention that the support 2 has at least two contact chambers 3 that are adjacent to one another and in which the contacts, not illustrated, are secondary-locked via a locking pin, a latching hook, a latching strip or the like of the locking tab 4.

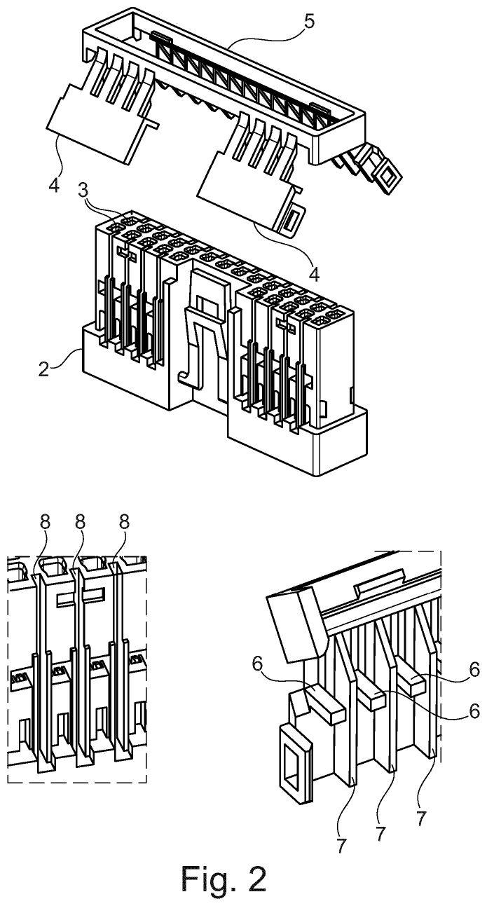

FIG. 2 shows the details of the plug-in connector 1 with improved protection against high-voltage flashovers. The frame 5 with its locking tabs 4 is shown on its own in the upper left illustration. The support 2 with its plurality of contact chambers 3 is illustrated in the lower left illustration of FIG. 2, and the frame 5 can be placed onto the support 2 and fixed there in a suitable manner (for example by latching).

The details of the locking tab 4 that face in the direction of the support 2 can be seen in the upper right illustration of FIG. 2. The essential details are of locking pins 6 (also to be referred to as latching hooks or the like) and webs 7 that, in this case, run between the individual locking pins 6. When the locking tab 4 is pivoted in the direction of the support 2, the locking pins 6 located on the inner side of the locking tab 4 enter the associated contact chambers 3 in the support 2 and bring about the fixing there of the contacts that have been previously inserted and primary-locked there. At the same time, the webs likewise located on the inner side of the locking tab 4 enter the associated slots 8 of the support 2 and bring about an extension there of the creepage distance for improved protection against high-voltage flashovers. Alternatively to individual locking pins 6, it can be conceived to provide a continuous web (that is then oriented transversely with respect to the webs 7), for example at the initially free end of the locking tab 4. Such a continuous web has the advantage that it can be used not only to bring about the secondary locking of the contacts in their contact chambers 3 when the locking tab 4 is pivoted, but also at the same time the locking tab 4 can be fixed in its correct end position on the support 2 by means of this continuous web. In the case of the embodiment illustrated in FIG. 2, the locking tab 4 can have further latching means, not illustrated, with which they can be fixed in their correct position on the support 2 after the pivoting process.

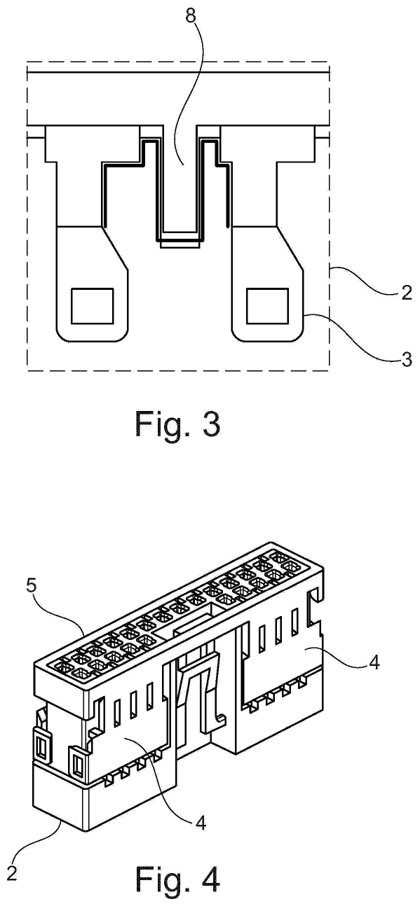

FIG. 3 illustrates a top view of the support 2 from the direction of the plug face (i.e., from above into the contact chambers). The slot 8 can also be seen there, through which the creepage distances is significantly extended. In this illustration, the web 7 that has been entered is not yet illustrated. The cross-sectional geometries, as are illustrated in FIG. 3, are likewise only by way of example and can vary depending on the use of the plug-in connector 1.

FIG. 4 finally shows the secondary locking in the closed state. It can be seen here that the frame 5 has been arranged at the one end of the support 2 and fixed in a suitable manner. The locking tabs 4 have likewise been pivoted into their correct end position and likewise fixed in the latter in a suitable manner. At the same time, the secondary locking of the contacts in their respective contact chambers 3 and the entry of the webs 7 on the inner side of the respective locking tab 4 into the associated slots 8 in the support 2 have taken place.

The individual elements of the plug-in connector 1 according to the invention can be advantageously produced reliably and in large piece numbers from a suitable plastic in a plastics injection molding process. During the shaping of the plug-in connector 1, in particular of the support 2 and/or of the frame 5, various polarizations and codings can be realized.

The plug-in connector 1, as illustrated in FIG. 4 (but with the omission of the contacts in the contact chambers and corresponding electrical lines), can be plugged together with a correspondingly formed mating plug connector to form a plug-in connection. The plugging together involves a simple plug-in operation that can be assisted by an additional locking (CPA: connector position assurance).

Summarized once again in other words, the invention relates to a plug-in connector that has a support that comprises at least two contact chambers into which a respective contact is inserted. The contact is locked once in the contact chamber, for example by means of its own latching tab (“primary locking”).

Furthermore, there is secondary locking that has the effect that the contact inserted into the contact chamber is fixed in the contact chamber in addition to the primary locking (“secondary locking”). According to the invention, the secondary locking is designed to fix the contact one further time in the contact chamber and also to bring about protection against high-voltage flashovers between two adjacent contacts.

### List of Reference Signs

1 Plug-in connector
2 support
3 Contact chamber
4 Locking tab
5 Frame
6 Locking pin
7 Web
8 Slot

1. A plug-in connector comprising:
a support formed with an array of contact chambers each constructed to hold a respective contact that is primary-locked there;
a locking tab that has respective locking pins secondary-locking the respective contacts in their contact chambers, the support being formed a slot between the contact chambers in the support, the locking tab having web that enter the slots when the locking tab is fitted to the support.

2. The plug-in connector according to claim 1, wherein the locking tab is pivotal on the support.

3. The plug-in connector according to claim 1, further comprising:
a frame is provided that is fixed on the support, the a locking tab being pivotal on the frame.

4. The plug-in connector according to claim 1, wherein a minimum clearance remains between a surface of the web and a confronting surface of the associated slot when the web has entered its the respective slot.

5. The plug-in connector according to claim 3, wherein the support and the frame are composed of identical or different plastic.
